(19) United States
(12) Patent Application Publication
(10) Pub. No.: US 2002/0180168 A1
(43) Pub. Date: Dec. 5, 2002

(54) Scooter

(76) Inventor: Salam K. Rizk, Corona, CA (US)

Correspondence Address: Sam Rizk, 1530 San Ponte Road, Corono, CA, 92882, US

(21) Appl. No.: 09/871,352

(22) Filed: May 30, 2001

(51) Int. Cl. B62M 1/00

(52) U.S. Cl. 280/87.041; 280/779

(57) ABSTRACT

A scooter comprising an elongated steering column, a steering system, and a braking system is disclosed and claimed. The steering system allows the elongated steering column to rotate about the longitudinal axis and to hinge in a vertical plane relative to the scooter body. The braking system relies upon contact between a braking arm and the crown of the rear wheel. Such a braking system allows the rider to regulate the amount of braking.

### BACKGROUND OF THE INVENTION

1. Field of the Invention

This invention relates to a scooter having a steering and braking systems. The steering system allows the user to rotate a steering column about the longitudinal axis to steer the scooter while also allowing the user to incline the steering column in a vertical plane. Inclination in the vertical plane does not translate into a change in direction of the scooter. The braking system engages the crown of the rear wheel.

2. Description of the Prior Art

Scooters have been around for many years and have recently enjoyed an increased popularity. There are a wide variety of scooters, for example, including motorized and non-motorized versions and two wheel and multi wheel adaptations.

Most scooters on the market today have at least two things in common. A brake system and a folding steering column.

The steering column folds usually in response to the operator collapsing the unit so that the scooter can be carried or stored. Once folded, the steering column is substantially parallel to the scooter body. In the operational position, the steering column is generally perpendicular to the scooter body and turns, much in the same way as a bicycle handlebar, to direct the scooter. In this position, the steering column is locked in place.

Most braking devices for scooters create resistance to the radial motion of the rear wheel either by clamping down on the top or sides of the rear wheel. This tends to be accomplished by the operator either stepping on the top of the braking device with one foot or by using a conventional hand brake similar to those found on bicycles. See U.S. Pat. Nos. D438,911 D433,718.

These two common elements in existing designs have limitations that are addressed by the present invention. First, when the steering column is in its upright position it does not allow the operator adequate flexibility during operation.

As the operator may desire to change the position of his/her body on the scooter to affect a maneuver, the steering column remains in a rigid upright position. This can make it more difficult for the rider to hold the handles of the steering column while shifting his/her body position since the column is not responsive to the moving rider.

However, a steering column that is too flexible is not desirable. A steering column that could swing outward from the scooter body or from side to side would tend to create imbalance. The body of the typical two-wheel scooter is very narrow and has a very limited center of balance. It would not take very much deviation from this center-line to cause the scooter to fall. A steering column that swings from side-to-side would tend to encourage deviation from the center of balance thereby causing the rider to fall.

Secondly, most braking systems do not offer an adequate range of deceleration. Brakes tend to either be in operation or not or they tend to lock-up if fully activated. When brakes do lock-up, the operator can be thrown from the scooter.

What is needed is a steering system that offers more flexibility than current systems and a braking system that offers the rider a range of braking force that is less likely to cause a lock-up.

### SUMMARY OF THE INVENTION

The invention is directed to a scooter having a steering column that can hinge in a vertical plane relative to the scooter body during operation and a braking system that utilizes the crown of the rear wheel for braking. The scooter has an elongated body member with front and rear ends that define a horizontal plane parallel to the scooter body member, a front and rear wheel, the rear wheel having a crown.

A steering system is at the front end of the scooter body and includes an elongated steering column defining a longitudinal axis, a connection assembly, a rotatable coupling, a front wheel and a post. The steering column has a top and bottom column ends. The steering column top end is adapted for use by an operator. This end can take the form of, for example, a perpendicular cross member. However, this is not exhaustive and does not restrict the use of other adaptations. The bottom end terminates at the connection assembly.

The connection assembly is comprised of a hinged rotatable joint and a bracket having a top and lower ends. The lower end is secured to the front end of the scooter body member. The bottom steering column end terminates at the hinged rotatable joint and the hinged rotatable joint is secured to the top end of the bracket.

The hinged portion of the hinged rotatable joint allows the steering column to incline in the vertical plane from a position that is substantially perpendicular to the scooter body member to a position that is substantially parallel to the scooter body member. The joint prevents the steering column from moving in the horizontal plane or from side to side. In other words, the hinged rotatable joint restricts the movement of the steering column to the vertical plane and about the longitudinal axis. As the steering column rotates about the longitudinal axis, the hinged rotatable joint rotates in response to the rotating column. The rotatable coupling translates this rotation to the post. As the post turns, the position of the front wheel changes. The inclination of the steering column in relation to the elongated scooter body does not translate into a change in the position of the front wheel.

One embodiment of a rotatable coupling includes a first coupling member that attaches to the steering column and a second coupling member that attaches to the top post end of the post. The two coupling members are connected such that rotation of the steering column about the longitudinal axis will rotate the post. When the steering column is in an upright position that is substantially perpendicular to the elongated scooter body, the column is positioned for the maximum degree of rotation about the longitudinal axis. As the steering column is inclined relative to the elongated scooter body, the degree of rotation about the longitudinal axis is less and the position of the front wheel is substantially independent from the inclination of the steering column.

A braking system is at the rear end of the scooter body. It comprises a braking arm disposed above the rear wheel. The braking arm has front and rear sections. The front section has opposing parallel sides and the rear section is generally in a v shape. Generally the point of intersection of the front and rear sections is where the braking arm comes into contact with the crown of the rear wheel to slow down the scooter. As this point is forced onto the crown, the resistance to the rotation of the wheel increases thus allowing the rider a range of resistance that corresponds to a range of braking force.

The braking arm is arced to more adequately conform to the surface of the rear wheel. A spring is used to bias the braking element above the rear wheel when no force is applied to the rear wheel.

Force can be transferred to the braking element in a number of ways. For example, a hand brake similar to those found on bicycles can be used or an element adapted to receive force from the rider's foot. The force overcomes the spring biasing and brings the braking element into contact with the crown of the rear wheel.

### BRIEF DESCRIPTION OF THE DRAWINGS

FIG. 1 is a side view of the scooter, steering system, and braking system with a foot activated brake;

FIG. 2 is a side view of the scooter, steering system, and braking system with a hand activated brake;

FIG. 3 is a side view of the steering system;

FIG. 4 is an exploded view of hinged rotatable joint;

FIG. 5 is a side view of the upper hinge member;

FIG. 6 is a front view of the upper hinge member;

FIG. 7 is a side view of the lower hinge member;

FIG. 8 is a front view of the lower hinge element;

FIG. 9 is a side view of the scooter braking system;

FIG. 10 is a top view of the braking arm;

FIG. 11 is a side view of the braking arm;

FIG. 12 is a side view of the inverted u shaped wheel brace;

FIG. 13 is a cross sectional view of the inverted u shaped wheel brace;

FIG. 14 is a front view of the rear wheel illustrating the crown section, which is engaged by the braking arm;

FIG. 15 depicts the braking arm biased above the rear wheel;

FIG. 16 depicts the braking arm making contact with the crown of the rear wheel;

FIG. 17 is a side view of the braking element for use with a hand activated braking system;

FIG. 18 is a side view of a hand operated braking actuator;

### DETAILED DESCRIPTION OF THE DRAWINGS

The present invention may best be understood by reference to the following description taken in conjunction with the accompanying drawings.

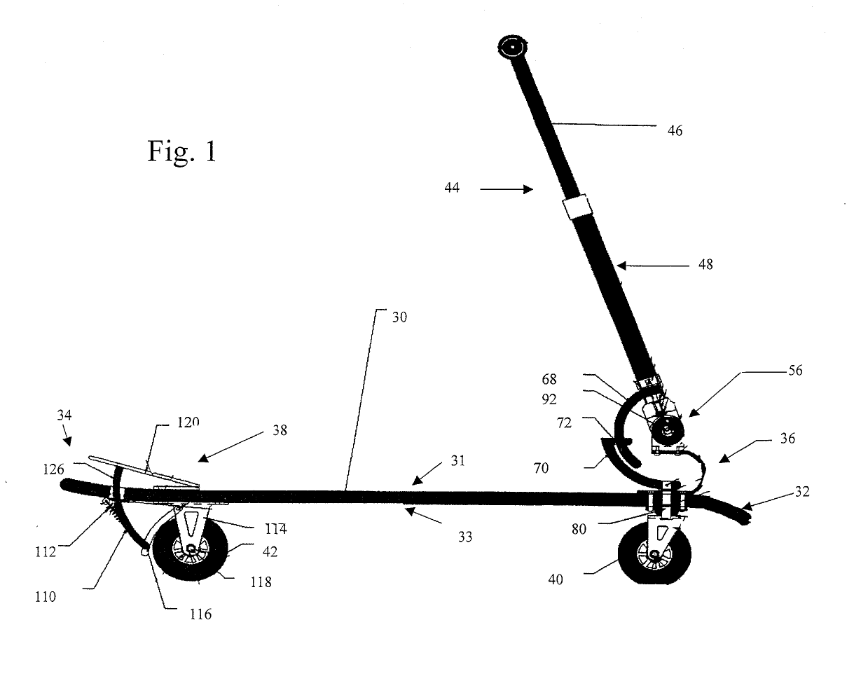

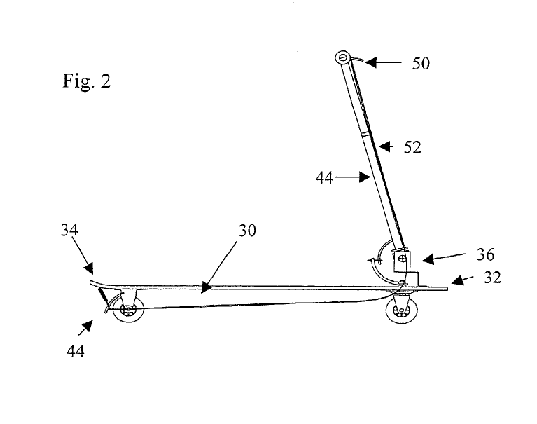

Referring now to FIG. 1, the scooter has an elongated body 30 with a front end 32 and a rear end 34, a top side 31 and a bottom side 33, a steering system 36, a braking system 38, a front wheel 40 and a rear wheel 42. The front wheel 40 and rear wheel 42 being disposed below the elongated scooter body. The elongated steering column has a top column end 46 and a bottom column end 48. The scooter in FIG. 2 is illustrated with a hand braking actuator 50, a cord 52, and a rear braking actuator 54. Returning now to FIG. 1, the elongated scooter body 30 forms a horizontal plane for reference. A vertical plane is formed perpendicular to the horizontal plane and in the direction of the elongated body 30.

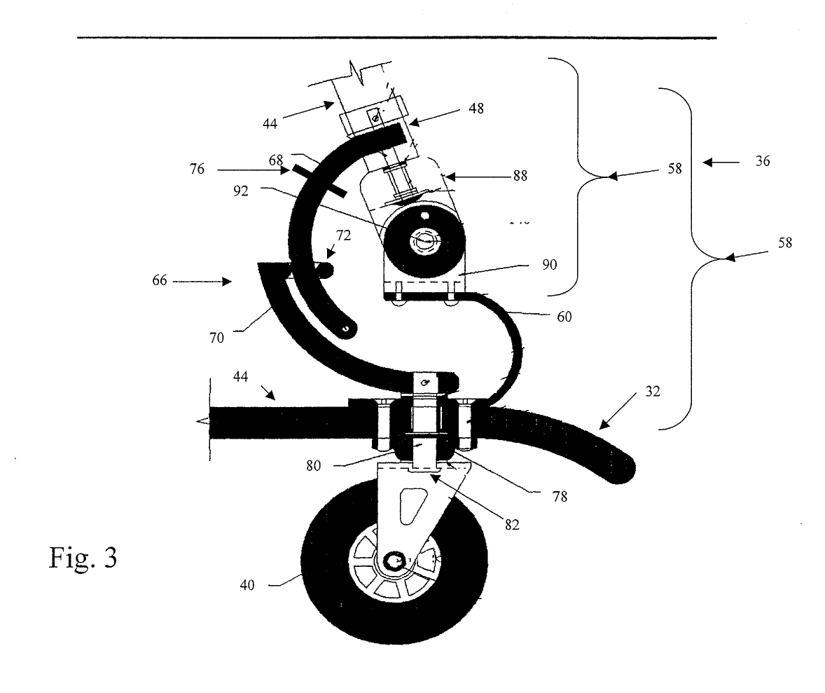

Referring now to FIG. 3, the steering system 36 is comprised of an elongated steering column 44 with a bottom column end 48, a connecting assembly 56 that has a hinged rotatable joint 58, a bracket 60 having a top end 62 and a bottom end 64. The bottom column end of the elongated steering column 48 is attached to the hinged rotatable joint 58. The hinged rotatable joint allows the elongated steering column 44 to be rotated about a longitudinal axis and hinged from a position that is about perpendicular to the body of the scooter 30 to a point that is generally parallel to the scooter body 30. The hinged rotatable joint 58 is secured to the top end of the bracket 62 and the bottom end of the bracket 64 is secured to the scooter body 30.

A rotatable coupling 66 is comprised of a first coupling member 68, a second coupling member 70, and a follower member 72. The first coupling member 68 is secured to the elongated steering column 44 and the second coupling member 70 is secured to the top post end 74. FIG. 3 identifies an embodiment where the first coupling member 68 can include a stopping unit 76 that serves to limit the vertical inclination of the steering column 36 in the vertical plane.

Referring again to FIG. 3, a bearing plate 78 secures the post 80 such that the post is free to rotate in the horizontal plane while remaining substantially in a fixed vertical location with respect to the scooter body. The follower member 72 is secured to the second coupling member 70 and allows the first coupling member 68 to move freely in the vertical plane as the elongated steering column 44 is pivoted from its vertical to its horizontal position. Such movement in the vertical plane does not cause the second coupling member 70 to rotate in the horizontal plane.

As the elongated steering column 44 is rotated about the longitudinal axis the first coupling member 68 rotates against the follower member 72. This rotation is transferred to the second coupling member 70, which rotates the post 80 through the vertical axis. As the post rotates, the bottom post end 82 rotates causing the axel 84 to rotate and in turn the front wheel 40 to rotate.

The steering system 36 allows the front wheel 40 to rotate in response to the rotation of the elongated steering column 44 about the longitudinal axis by the rider. The elongated steering column 44 is free to pivot in the vertical plane while being rotated about the longitudinal axis. However, the elongated steering column 44 is not free to pivot or swing from side to side. The elongated steering column 44 is constrained to pivoting in the vertical plane.

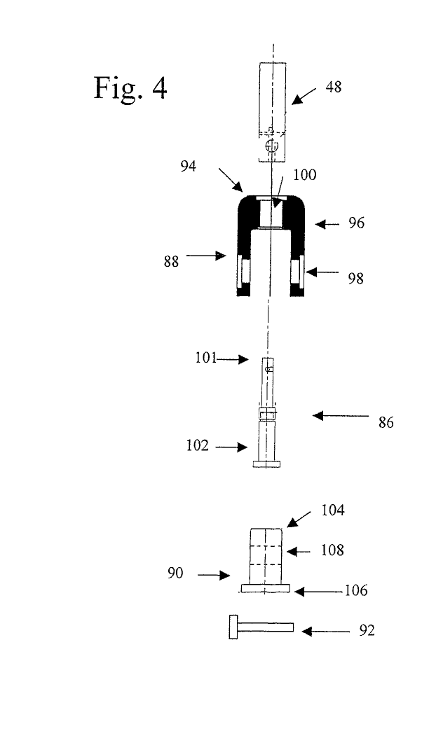

FIG. 4 is an exploded view of the hinged rotatable joint 58 comprising a rotatable connector 86 that can be of the form of a clevis pin, a hinge that is comprised of an upper hinge member 88, and a lower hinge member 90, and a hinge pin 92. The upper hinge member has a top side 94, opposing sides 96 having a hole 98, and an opening 100. The top of the rotatable connector 101 fits through the opening 100 and the bottom of the rotatable connector 102 is captured by the shoulder so that the connector 86 is free to rotate within the top 94 of the upper hinge member. The lower hinge element 90 has an elevated side 104, a base 106, and a hole in the lower hinge member 108. When assembled, the rotatable connector 86 is secured in the upper hinge member 94, the bottom of the steering column 48 is secured to the rotatable connector 86, and the upper hinge member 88 is pivotably secured to the lower hinge member 90 by use of the hinge pin 92. The rotatable connector 86 can rotate freely within the upper hinge member 88 in response to rotation of the elongated steering column 44 about the longitudinal axis. The base of the lower hinge member 106 is secured to the top of the bracket 62 as in FIG. 3. The bottom of the bracket 64 is secured to the scooter body 44.

Since the lower hinge member 90 is secured in place, the upper hinge member 88 is only allowed to hinge in the vertical plane about the hinge pin. Therefore, the elongated steering column 44 can only hinge in the vertical plane and not from side to side. In one embodiment, the degree of inclination of the steering column can be restricted by inserting a pin through the upper and lower hinge members. In another embodiment, a pin can engage a track that would allow the upper member to hinge, but only until making contact with the pin.

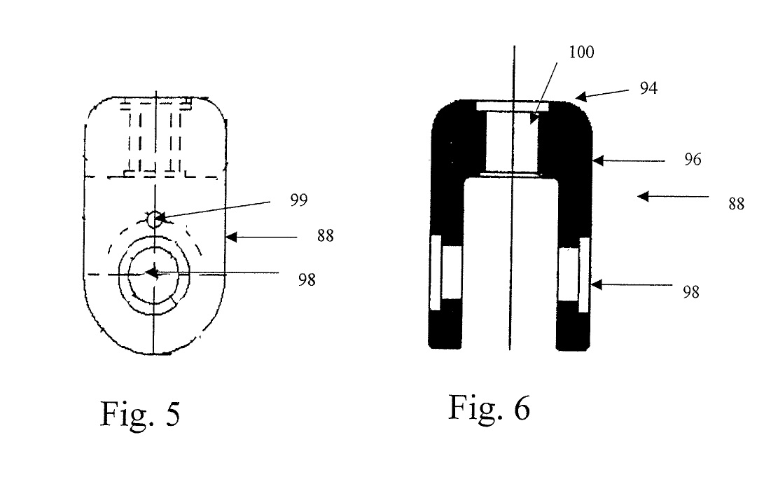

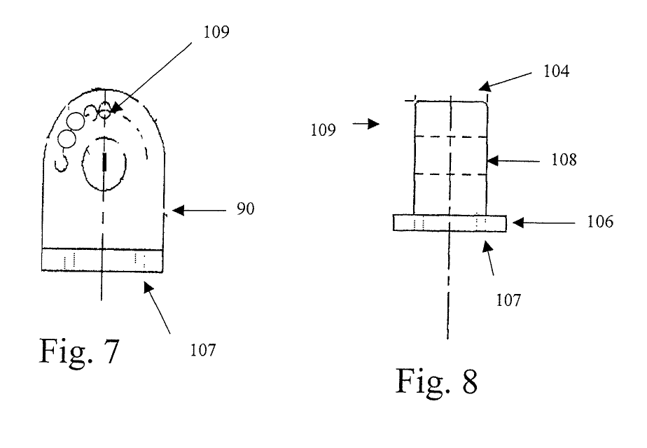

As shown in FIG. 5 is a side view of the upper hinge member 88 and FIG. 6 is a front view of the upper hinge member 90. In FIG. 5 a pin receiving hole 98 is visible and is used to restrict the inclination of the steering column when used the lower hinge member. When a pin is used in conjunction with the pin receiving hole 99 and one of the many pin receiving holes 109, this becomes a stopping unit. Another stopping unit would be the use of a pin, or equivalent device, attached to the first coupling member 68 to restrict the movement of the first coupling member as explained supra. FIG. 7 is a side view of the lower hinge member 90 and FIG. 8 is a front view of the lower hinge member 90. In FIG. 7 the pin receiving holes 108 is present that can be used in conjunction with the pin receiving hole 98 to restrict the inclination of the steering column 44. Securing holes 107 are used to secure the lower hinge member 90 to the scoter body 30.

The hole in the upper hinge member 98 corresponds with the holes in the lower hinge member 108 and receives the hinge pin 92. This allows the upper hinge member 88 to pivot in response to the movement of the steering column 44, but does not allow the steering column 44 to move within the horizontal plane or from side to side.

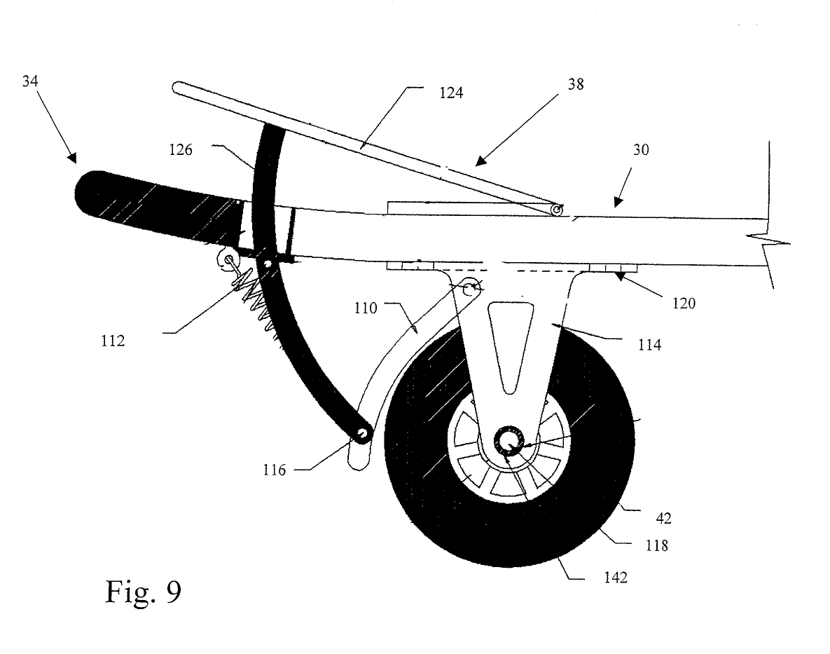

Turning now to FIG. 9, the braking system 38 is comprised of a braking arm 110, spring 1125, inverted u shaped wheel brace 114, braking actuating end 116, and an axel 118. The top side 120 of the brace 114 is secured to the elongated scooter body 30 while the u shape of the wheel brace 114 receives the rear wheel 42 in the space created by the opposing sides 123. An axel 118 fits through the hole in the wheel brace 122 and the hole in the back wheel, rotatably securing the back wheel in the wheel brace 114. In this embodiment, the braking is accomplished by the operator applying force onto the foot rest 124. The force is transmitted through the armature 126 to the braking arm 110. This force overcomes the bias of the spring and brings the braking arm into contact with the crown of the wheel thereby slowing the scooter.

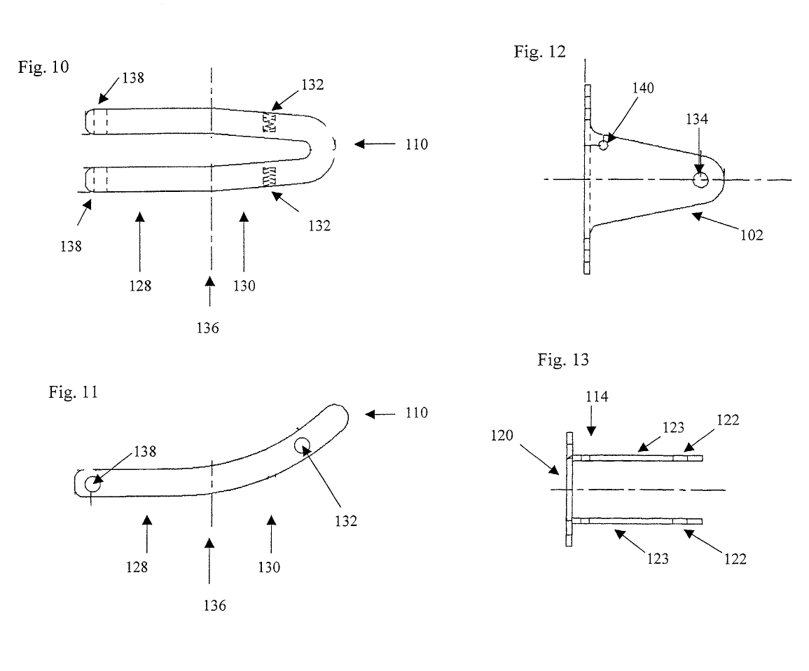

The braking arm 110 of FIG. 10 is secured above the back wheel as shown in FIG. 9. In FIG. 10 the front of the braking arm 110 and the rear of the braking arm 130 are displayed. As shown in FIG. 11, the braking arm 110 is curved and generally conforms to the curve of the back wheel. The spring 112 is secured by the first end to the scooter body and the second end to the braking arm 130 in the hole 132 as in FIG. 8. A braking actuating end 116 provides the force necessary to overcome the force of the spring and slow the scooter. Referring back to FIG. 11, the braking actuator attaches to the braking arm 110 at the hole 132.

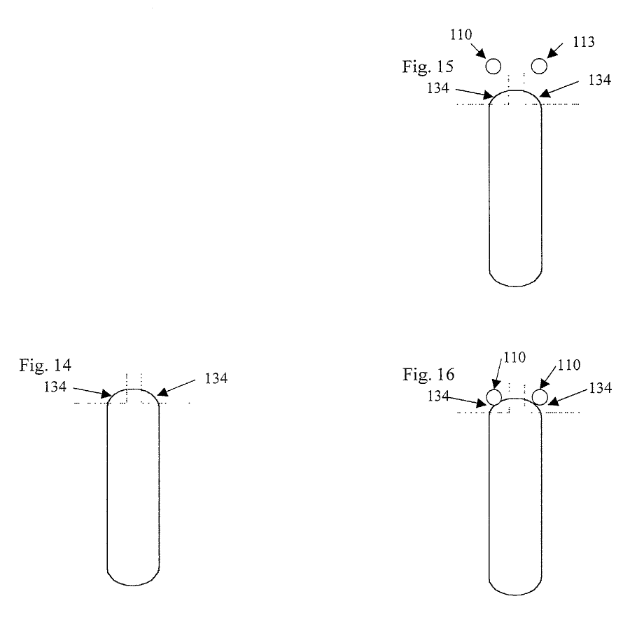

FIG. 14 identifies the crown 134 of the back wheel. The crown does not include the top of the back wheel, but rather the sides leading to the top. FIG. 15 displays how the braking arm 110 is above the rear wheel 42 when the brake is not activated. When the braking system is activated, the braking arm 110 comes into contact with the crown 134 of the back wheel. This creates resistance to the rotation of the back wheel and slows the scooter.

FIG. 10 shows the front section 128 and rear section 130 of the braking arm 110 and the intersection point 136. The front section 128 is generally parallel while the rear section 130 is generally in the shape of a v. The braking arm 110 engages the crown at approximately the intersection point 136. The degree of force applied to the crown controls the amount of slowing of the scooter.

The holes 138 identified in FIG. 10 align with the holes 140 of FIG. 12 so that the braking arm can be rotatably secured to u shaped wheel base 114 by way of a braking pin 142 as shown in FIG. 8. The hole 132 of FIG. 10 receives the second end of the spring.

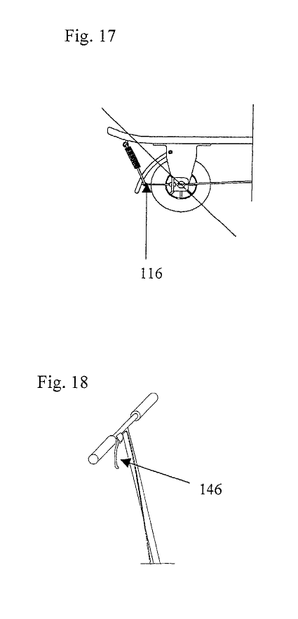

FIG. 17 is an example of a braking system that has a braking actuator end 116. FIG. 18 displays the user actuating end 146 of the barking system when the user actuating end is similar to a bicycle hand brake.

There has thus been described a novel scooter. Various modifications and improvements to the system will occur to those skilled in the art without involving a departure from the spirit and scope of the invention as defined in the appended claims.

What is claimed is:

1. A scooter comprising:
a scooter body member being elongated and having a front end and a rear end and defining a horizontal plane parallel to the scooter body member, a rear wheel defining a crown, and a front wheel;
a steering system disposed adjacent to the front end of the scooter body member and having an elongated steering column with a longitudinal axis, a connection assembly, a rotatable coupling, and a post;
the steering column having a top column and bottom column ends, the top column end adapted for use with an operator;
the connection assembly having a hinged rotatable joint, a bracket with a top end and a lower end, the lower end being secured to the scooter body and the top end adapted to receive the hinged rotatable joint, the hinged rotatable joint being adapted to receive the bottom column end of the steering column, the hinged rotatable joint allowing the steering column to be inclined from a vertical position in a vertical plane and allowing the rotation of the steering column about the longitudinal axis;
the post adapted to receive the front wheel;
the rotational coupling translating rotation of the column about the longitudinal axis to the post thereby rotating the front wheel in the horizontal plane;
the position of the front wheel being independent of the inclination of the steering column in the vertical plane;
a braking system disposed substantially at the rear end of the scooter body member having a braking arm disposed above the crown of the rear wheel; and
the braking arm movable such that the braking arm come into contact with the crown.

2. A scooter steering system disposed substantially along the front end of an elongated scooter body for use with a front wheel, an elongated steering column with a longitudinal axis and the elongated scooter body defining a horizontal plane parallel to the elongated scooter body comprising;
a hinged rotatable joint;
a rotatable coupling;
a post;
the steering column having a top column and bottom column ends, the top column end adapted for use with an operator;
the hinged rotatable joint being interposed between the scooter body and the bottom column end;
the hinged rotatable joint being adapted to receive the bottom column end of the steering column, the hinged rotatable joint allowing the steering column to be inclined from a vertical position in a vertical plane and allowing the rotation of the steering column about the longitudinal axis;
a post adapted to receive the front wheel;
the rotational coupling translating rotation of the column about the longitudinal axis to the post thereby rotating the wheel in the horizontal plane;
the position of the front wheel being independent of the inclination of the steering column in the vertical plane.

3. A scooter steering system disposed substantially along the front end of an elongated scooter body for use with a front wheel, the elongated scooter body defining a horizontal plane parallel to the elongated scooter body comprising:
a steering column having an elongated body with an upper and lower end and a longitudinal axis;
a connection assembly having a hinged rotatable joint and a bracket having a top end and a lower end, the hinged rotatable joint being adapted to receive the lower end of the steering column, the top end of the bracket being adapted to receive the hinged rotatable joint and the lower end being attached to the elongated scooter body;
the hinged rotatable joint allowing the steering column to incline in a vertical plane and to rotate about the longitudinal axis;
the front wheel having an axis of rotation and an axel through the axis of rotation of the front wheel;
a post having a top post and bottom post ends, the bottom post end adapted to receive the axel of the wheel, and the post being positioned substantially perpendicular to the elongated scooter body;
a rotatable coupling having a first coupling member and a second coupling member the coupling members being generally in the shape of an arc, a follower member disposed on one coupling member and adapted to receive the other coupling member such that the other coupling member is slidably movable within the following member;
the second coupling connector being secured to the steering column;
the first coupling member being secured to the top post end; and
the wheel being responsive to the rotation of the post as the rotation of the steering column about the longitudinal axis is translated by the rotatable coupling to the post.

4. The scooter steering system of claim 3 wherein the hinged rotatable joint comprises:
a hinged apparatus having an upper and lower hinge member;
a hinge pin;
a rotatable connector;
the rotatable connector having a top portion and bottom portion of the general shape of a cylinder and the bottom portion terminating in the general shape of an annular shoulder having a radius greater than the radius of the cylinder of the top and bottom portions;
the upper hinge member being generally of the shape of an inverted u and having a top and opposing sides, the opposing sides having a hole and the top being adapted to receive the rotatable connector;
the lower hinge member being generally in the shape of an inverted t and having a top and base ends, the top end of the lower hinge member having a hole coincident with the hole in the opposing sides of the upper hinge member;
the upper hinge member receiving the rotatable connector;
the top of the rotatable connector being adapted to securely receive the bottom end of the steering column;
the hinge pin pivotably securing the top hinge member to the upper portion of the lower hinge member;
the base of the lower hinge member being secured to the top of the bracket; and
the upper hinge member being hingable about the hinge pin allowing the steering column to incline and the rotatable connector allowing the steering column to rotate about the longitudinal axis.

5. A scooter braking system disposed substantially along the back bottom end of an elongated scooter body having a rear wheel, the elongated scooter body defining a horizontal plane parallel to the elongated scooter body comprising:
an inverted u shaped wheel brace having opposing sides and a top side;
the rear wheel having a center of rotation, and a crown;
an axel;
a braking arm having a front and back sections and an intersection of the front and back sections, the front section having opposing sides and being substantially parallel, the opposing sides converging at the intersection of the front and back sections such that the back section is generally in the form of a v;
a spring having a first and second ends;
the axel being adapted to be received through the center of rotation of the back wheel;
the top side of the wheel brace being secured to the bottom of the scooter body, the opposing sides of the wheel brace having holes being adapted to receive the wheel and the axel throughwith;
the braking arm being disposed above the crown of the back wheel, the front section of the braking arm being adapted to be received in the opposing sides of the u shaped wheel brace;
the first end of the spring secured to the braking arm at a point substantially to the back section of the braking arm;
the second end of the spring being secured to the bottom of the scooter body;
the spring biasing the braking arm above the crown of the wheel; and
when force is applied to the braking arm the opposing sides of the braking arm coming into contact with the crown of the wheel creating resistance to the rotation of the wheel.

6. The scooter braking system of claim 5 for use with an elongated steering column top end adapted for use by an operator further comprising:
a braking actuator apparatus having a user actuating end and a braking actuating end;
the user actuating end disposed on the elongated steering column top end and responsive to force from the operator;
the braking actuating end disposed generally on the back end of the braking arm; and
force from the operator on the user actuating end causing the braking actuating end to bring the braking arm into contact with the crown of the back wheel, thereby creating resistance to the rotation of the back wheel.

7. The scooter braking system of claim 5 for use with an operator's foot further comprising:
a foot rest;
an elongated armature;
the elongated armature being pivotably secured at one end to the braking arm and the other end being pivotably secured to the foot rest;
the foot rest transmitting force applied by the operator's foot to the elongated armature;
the elongated armature transmitting the force from the foot rest to the braking arm; and
the braking arm coming into contact with the crown of the back wheel, thereby creating resistance to the rotation of the back wheel.

8. The scooter braking system of claim 5, wherein, the opposing sides of the front section of the braking arm defines a horizontal plane, the front section having a front end, the rear section having a rear end, the braking arm curves generally in the shape of an arc from the front end to the rear end in relation to the rear wheel.

9. The scooter braking system of claim 8, further comprising a braking pin and wherein:
the inverted u shaped wheel brace having a hole in the opposing sides disposed toward the rear of the scooter body and toward the top side of the u shaped wheel brace;
the opposing sides of the front section of the braking arm having a hole disposed generally toward the front end of the front section;
the wheel brace being adapted to receive the front end of the front section of the braking arm such that the holes in the front section are in alignment with the holes in the wheel brace; and
the holes in the front end of the front section of the braking arm and the holes in the inverted u shaped wheel brace being adapted to receive the brake pin.

10. The scooter brake system of claim 9 wherein the rear portion of the braking arm having a hole adapted to receive the first end of the spring.

11. The scooter brake system of claim 9 wherein the rear portion of the breaking arm having a hole adapted to receive a braking actuating end.

12. The scooter brake system of claim 5 wherein the crown of the rear wheel contacts generally about the intersection of the front and back sections of the braking arm when the braking element engages the crown of the rear wheel.

13. The scooter steering system of claim 2 wherein the post is rotatably connected to scooter body member.

14. The scooter of claim 1 further comprising a stopping unit having a pin receiving hole in the upper hinge member and a plurality of pin receiving holes in the lower hinge member, the pin receiving hole in the upper hinge member alignable with any of the plurality of pin receiving holes in the lower hinge member and adapted to receive a pin for selecting an inclination for the elongated steering column thereby limiting the vertical incline of the elongated steering column.

15. The scooter of claim 1 further comprising a stopping unit adapted for use with the hinged rotatable joint to limit the vertical incline of the elongated steering column.

16. The scooter steering system of claim 3 further comprising a stopping unit adapted for use with the first coupling member to limit the vertical incline of the elongated steering column.

17. The scooter of claim 1 wherein the length of the elongated steering column can be varied by the operator.

18. The scooter steering system of claim 3 wherein the length of the elongated steering column can be varied by the operator.

19. The scooter of claim 1 wherein the elongated scooter body has a top and bottom side and the front and back wheels are disposed on the bottom side of the elongated scooter body.

20. The scooter of claim 1 wherein the position of the front wheel is substantially independent of the inclination of the steering column.

21. The scooter of claim 3 wherein the position of the front wheel is substantially independent of the inclination of the steering column.

22. The scooter of claim 1 wherein the elongated scooter body has a top and bottom side and the front and rear wheels are disposed along the bottom of the elongated steering column.

23. The scooter of claim 3 wherein the elongated scooter body has a top and bottom side and the front and rear wheels are disposed along the bottom of the elongated steering column.
